(19) United States
(12) Patent Application Publication
(10) Pub. No.: US 2013/0075981 A1
(43) Pub. Date: Mar. 28, 2013

(54) SEALING ARRANGEMENT

(71) Applicant: Jeff Wagner, Delphi, IN (US)

(72) Inventor: Jeff Wagner, Delphi, IN (US)

(73) Assignee: Caterpillar Inc., Peoria, IL (US)

(21) Appl. No.: 13/246,171

(22) Filed: Sep. 27, 2011

(51) Int. Cl. F16L 21/04; F16L 21/035; F16L 21/00

(52) U.S. Cl. 277/619; 277/626; 277/625

(57) ABSTRACT

A sealing arrangement for connecting a first pipe and a second pipe. The sealing arrangement includes a first flange and a second flange circumferentially disposed on the first pipe and the second pipe respectively. The sealing arrangement further includes a damping member. The damping member includes a first slanted side supported by the first flange. In the sealing arrangement, the second flange couples with the first flange. The damping member provides a compression seal between the first pipe and the second pipe. Further, the damping member is configured to reduce the vibrations in the sealing arrangement.

### TECHNICAL FIELD

The present disclosure relates to a sealing arrangement, and more particularly to a sealing arrangement having a damping member.

### BACKGROUND

Conventional sealing arrangement may employ an o-ring to provide a seal between a first pipe and a second pipe. Such sealing arrangement may have radial movement between the first pipe and the second pipe due to vibrations caused by turbulence in a fluid flowing through the first pipe and the second pipe.

U.S. Pat. No. 4,170,375 (hereafter referred to as '375 patent) discloses a pipe joint with a sealing assembly. The sealing assembly includes a packing means disposed in a clearance between a first pipe member and a second pipe member. The '375 patent further discloses a pressure applying means for applying axial pressure against the sealing assembly.

### SUMMARY

In one aspect, the present disclosure provides a sealing arrangement for a first pipe and a second pipe. The sealing arrangement includes a first flange circumferentially disposed on the first pipe. The sealing arrangement further includes a damping member circumferentially disposed in contact with the first pipe. The damping member includes a first slanted side which is supported by the first flange. Further, the sealing arrangement includes a second flange radially extending from the second pipe, such that the second flange is configured to couple with the first flange.

In another aspect, the present disclosure provides a sealing arrangement for the first pipe and the second pipe. The sealing arrangement includes the first flange circumferentially disposed on the first pipe. The sealing arrangement further includes the damping member circumferentially disposed in contact with the first pipe. The damping member includes the first slanted side which is supported by the first flange. Further, the sealing arrangement includes an auxiliary flange circumferentially disposed on the first pipe. The auxiliary flange is configured to press the damping member against the first flange. Further, the auxiliary flange is configured to couple with the first flange.

Other features and aspects of this disclosure will be apparent from the following description and the accompanying drawings.

### BRIEF DESCRIPTION OF THE DRAWINGS

FIG. 1 illustrates a sectional view of a sealing arrangement with a damping member, according to an aspect of the present disclosure;

FIG. 2 illustrates a sectional view of a sealing arrangement having a sealing member in combination with the damping member, according to another aspect of the present disclosure; and

FIG. 3 illustrates the sealing arrangement of FIG. 2 with a backing member.

### DETAILED DESCRIPTION

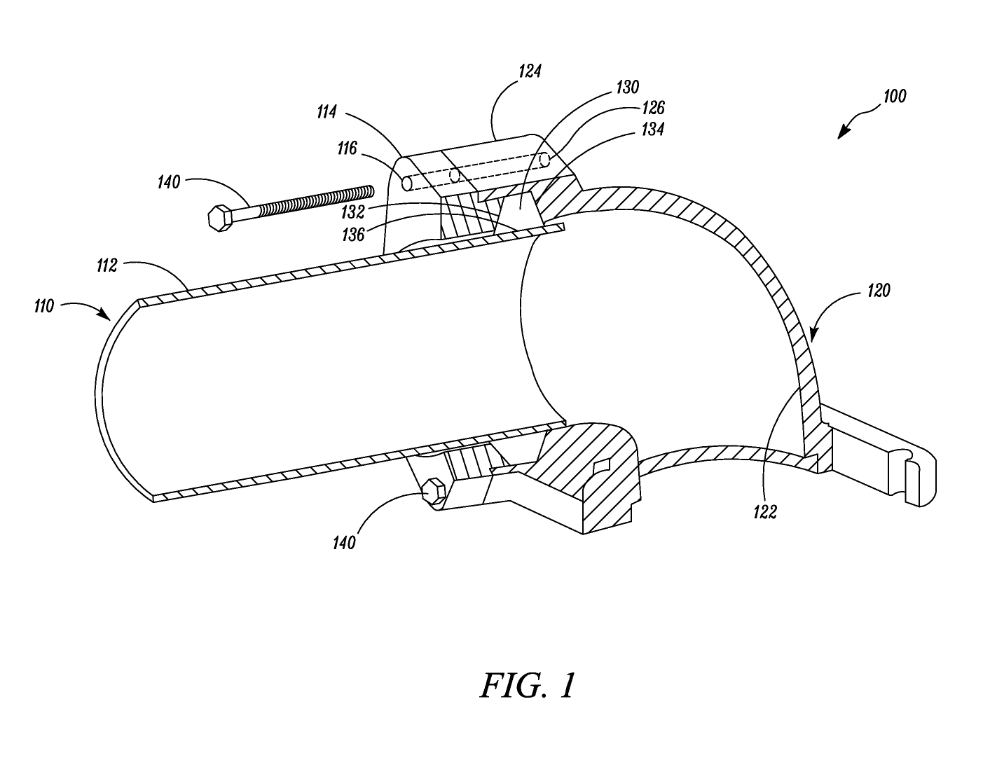

The present disclosure will now be described in detail with reference being made to accompanying figures. FIG. 1 illustrates a sectional view of a sealing arrangement 100 between a first pipe 110 and a second pipe 120, according to an embodiment of a present disclosure. The sealing arrangement 100 may provide a connection between the first pipe 110 and the second pipe 120. The sealing arrangement 100 may be employed in various applications which may include, but not limited to, an engine jacket-water cooling circuit, a separate circuit after-cooler, an engine oil-cooler or the like.

The first pipe 110 and the second pipe 120 may be made of any suitable material like stainless steel, aluminum, plastic, copper, etc. The first pipe 110 may include an exterior surface 112 and the second pipe 120 may include an interior surface 122. In the sealing arrangement 100, the exterior surface 112 and the interior surface 122 may mate with each other. Further, the first pipe 110 and the second pipe 120 may have a circular or an elliptical cross-section. In the illustrated embodiment, the first pipe 110 and the second pipe 120 are tubular structures and have a substantially circular cross-section, with the second pipe 120 having a larger diameter as compared to the first pipe 110.

In the sealing arrangement 100, the first pipe 110 may be partially surrounded by the second pipe 120. In an embodiment, the second pipe 120 may include a step (not illustrated) at one of axial ends to accommodate the first pipe 110 inside the second pipe 120. The step may be provided for the abutment of the first pipe 110 with the second pipe 120. In another embodiment, one of the first pipe 110 and the second pipe 120 may include an elbow (not illustrated) to allow for angular fitting between the first pipe 110 and the second pipe 120.

In an embodiment, a first flange 114 circumferentially disposed on the exterior surface 112 of the first pipe 110. Further, a second flange 124 may be integral with the second pipe 120, and radially extending from the second pipe 120. The first flange 114 and the second flange 124 may be in conformity with each other. In the illustrated embodiment, the first flange 114 and the second flange 124 may be extending in a radially outward direction, such that the diameter of the first flange 114 and the second flange 124 is larger than the diameters of the respective first pipe 110 and the second pipe 120. Moreover, the first flange 114 and the second flange 124 may include one or more through-holes 116 and 126 respectively, which may be inline with each other and internally threaded.

In an embodiment, the sealing arrangement 100 includes a damping member 130. The damping member 130 may act as a gasket interposed between the first pipe 110 and the second pipe 120. The damping member 130 may be made of an elastomeric material, such as polyacrylic rubber, silicone rubber, fluorocarbon rubber, or the like which are well known in the art. In an embodiment, the damping member 130 may include a stainless steel gripping ring in contact with the exterior surface 112 of the first pipe 110, which restrains the damping member 130 against the first pipe 110. The damping member 130 may be a resilient structure configured to undergo contraction or expansion under radial forces, thus providing a dampening effect.

In the sealing arrangement 100, the damping member 130 may include a slanted side. In an embodiment of the present disclosure, the damping member 130 includes two slanted sides, a first slanted side 132 and a second slanted side 134. In an embodiment, the damping member 130 may have a trapezoidal cross-sectional shape. The damping member 130 may be circumferentially disposed in contact with the exterior surface 112 of the first pipe 110. The damping member 130 may be placed in the sealing arrangement 100 such that a wider side 136 of the damping member 130 is in contact with the exterior surface 112 of the first pipe 110. In an alternative embodiment, the damping member 130 may be circumferentially disposed on the second pipe 120.

In an embodiment, one of the first slanted side 132 or the second slanted side 134 is in contact with the first flange 114. In the illustrated embodiment of FIG. 1, the first flange 114 is in contact with the first slanted side 132 to support the damping member 130. Similarly, the second flange 124 is in contact with the second slanted side 134. In an embodiment, both the first flange 114 and the second flange 124 may be extruding in the axial direction, converging towards each other as L-shaped members forming a sleeve to receive the damping member 130.

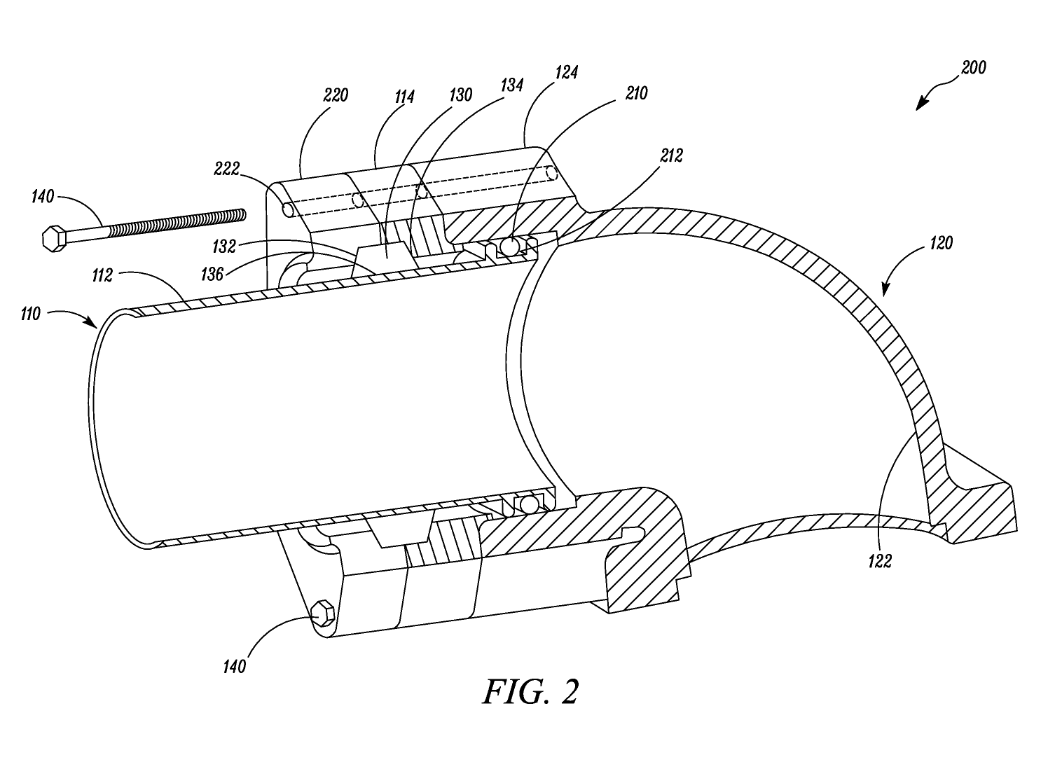

FIG. 2 illustrates another embodiment of a sealing arrangement 200 employing the damping member 130 and a sealing member 210. As illustrated in FIG. 2, the damping member 130 may be positioned such that the second slanted side 134 is in contact with the first flange 114. This allows for the damping member 130 to be detachably mounted in the sealing arrangement 200.

In an embodiment, the first pipe 110 includes a groove 212 disposed on the exterior surface 112. In the sealing arrangement 200, the sealing member 210 may be receivable in the groove 212. In the exemplary embodiment of FIG. 2, the sealing member 210 may be positioned adjacent to the damping member 130 and in a manner, such that the sealing member 210 is closer to the axial end of the first pipe 110.

In the sealing arrangement 200, the sealing member 210 may be an o-ring seal made of an elastomeric material like fluorocarbon rubber, silicone rubber, etc. Alternatively, the sealing member 210 may be made of metals or composites, well known in the art. The sealing member 210 may have annular shape conforming to the first pipe 110 and the second pipe 120. The sealing member 210 may provide a seal between the first pipe 110 and the second pipe 120, preventing a fluid to leak flowing through the first pipe 110 and the second pipe 120. In an embodiment, the sealing arrangement 200 may include a plurality of the sealing members 210.

As illustrated in FIG. 2, the sealing arrangement 200 may also include an auxiliary flange 220. In an embodiment, the auxiliary flange 220 may be similar to the first flange 114, interchangeably used with the first flange 114 in the sealing arrangement 200. The auxiliary flange 220 may be circumferentially disposed on the exterior surface 112 of the first pipe 110. The auxiliary flange 220 may be a rigid structure to press the damping member 130 against the first flange 114. The auxiliary flange 220 may allow the damping member 130 to be detachably mounted in the sealing arrangement 200.

In an embodiment, the auxiliary flange 220 may have an inclined side, in contact with the damping member 130 at the first slanted side 132. Further, the auxiliary flange 220 may also include one or more through-holes 222 with internal threads, corresponding to the through-holes 116, 126 (as illustrated in FIG. 1). In other embodiments, the auxiliary flange 220 may be disposed on the second pipe 120, pressing the damping member 130 against the second flange 124.

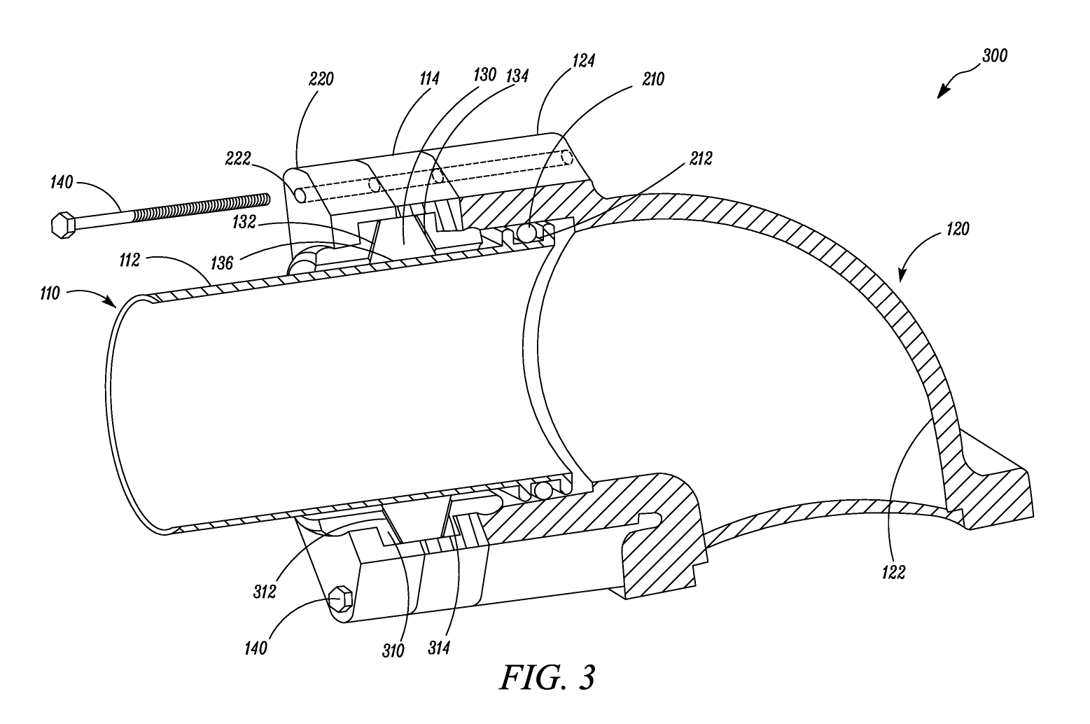

FIG. 3 illustrates an embodiment of a sealing arrangement 300 with the sealing member 210 providing a seal between the first pipe 110 and the second pipe 120. The sealing arrangement 300 may include a backing member 310 to support the damping member 130. The backing member 310 may be mounted over the damping member 130. The backing member 310 may include inclined surfaces 312, 314 corresponding to the shape of the slanted sides 132, 134 and thus conforms to the shape of the damping member 130. In an embodiment, the backing member 310 may be split in half backer rings disposed in contact with the first slanted side 132 and the second slanted side 134, providing better support to the damping member 130.

In an embodiment, the first pipe 110 may be locked with the second pipe 120 by a fastening member 140. The fastening member 140 may include nuts and bolts, rivets or the like. The fastening member 140 may have external threads and receivable in the through-holes 116, 126, running through the first flange 114 and the second flange 124. Further, in the embodiment of FIGS. 2 and 3, the fastening member 140 may also pass through the through-holes 222 along with the through-holes 116, 126 to lock the auxiliary flange 220 with the first pipe 110 and the second pipe 120. Thus, the fastening member 140 ensures a tight seal between the first pipe 110 and the second pipe 120, with the damping member 130 in between.

### INDUSTRIAL APPLICABILITY

Referring to the FIGS. 1-3, during operation the sealing arrangement 100 may be employed for connecting the first pipe 110 and the second pipe 120. A sealing member, such as the sealing member 210, may be disposed between the first pipe 110 and the second pipe 120 to provide a seal between the first pipe 110 and the second pipe 120. However, vibrations due to turbulence in the fluid flowing through the first pipe 110 and the second pipe 120 may cause a relative radial movement between the first pipe 110 and the second pipe 120. The radial movement between the first pipe 110 and the second pipe 120 may cause a leakage or loss of pressure of the fluid flowing through the first pipe 110 and the second pipe 120.

To reduce the radial movement of the first pipe 110 with respect to the second pipe 120, the damping member 130 may be employed in the sealing arrangement 100. The damping member 130 may provide a compression seal between the first pipe 110 and the second pipe 120. The damping member 130 may absorb vibrations by undergoing contraction and expansion under the action of turbulent forces, thereby reducing the damage caused to the sealing arrangement 100. The damping member 130 may therefore aid in aligning the first pipe 110 and the second pipe 120 coaxially, and minimize the turbulence in the fluid flowing therein. The damping member 130 may further be configured to reduce the angular misalignment of the first pipe 110 with respect to the second pipe 120.

The slanted sides 132, 134 may allow the damping member 130 to be easily received in the sealing arrangement 100. This allows for slidably mounting the damping member 130 in the sealing arrangement 100. Further, the slanted sides 132, 134 may reduce slip by providing a large contact area. This may ensure for the better retention of the damping member 130 and prevent the damping member 130 from being forced out of position due to high fluid pressure in the sealing arrangement 100.

In the embodiment of FIG. 2-3, the damping member 130 may be adaptable to be retro-fitted with the sealing arrangement 200 and the sealing arrangement 300 during assembly. This allows the damping member 130 to be used with the existing sealing arrangements. This may further reduce the clamping force required during assembling of the sealing arrangement 200 and therefore avoids developments of stress cracks in the first pipe 110 or the second pipe 120.

The auxiliary flange 220 may press the damping member 130 against the first flange 114. This limits the axial extrusion of the damping member 130 in the sealing arrangement 200. The damping member 130 may thus be able to undergo expansion and contraction in the radial direction, absorbing the vibrations due to turbulence. The backing member 310 disposed between the damping member 130 and the auxiliary flange 220 may further prevent the axial extrusion of the damping member 130. The auxiliary flange 220 may press the backing member 310, which in turn press the damping member 130 against the first flange 114.

Although the embodiments of this disclosure as described herein may be incorporated without departing from the scope of the following claims, it will be apparent to those skilled in the art that various modifications and variations may be made to the disclosed sealing arrangements 100, 200, and 300, more particularly to the positioning of the damping member 130. Other embodiments will be apparent from consideration of the specification and practice of the disclosure. It is intended that the specification and examples be considered as exemplary only, with a true scope being indicated by the following claims and their equivalents.

What is claimed is:

1. A sealing arrangement for a first pipe and a second pipe, the sealing arrangement comprising:
a first flange circumferentially disposed on the first pipe;
a damping member circumferentially disposed in contact with the first pipe, the damping member having a first slanted side supported by the first flange; and
a second flange radially extending from the second pipe, the second flange configured to couple with the first flange.

2. The sealing arrangement of claim 1, wherein the damping member have a second slanted side supported by the second flange.

3. The sealing arrangement of claim 2, wherein the damping member is disposed between the first flange and the second flange.

4. The sealing arrangement of claim 1, wherein the damping member has a trapezoidal cross-section.

5. The sealing arrangement of claim 4, wherein a wider side of the damping member is in contact with the first pipe.

6. The sealing arrangement of claim 1, wherein the damping member is made of an elastomeric material.

7. The sealing arrangement of claim 1, wherein the damping member is configured to align the first pipe and the second pipe coaxially.

8. The sealing arrangement of claim 1, wherein the damping member is further configured to provide a compression seal between the first pipe and the second pipe.

9. The sealing arrangement of claim 1 further including a sealing member receivable in a groove on an exterior surface of the first pipe, wherein the sealing member configured to provide a seal between the first pipe and the second pipe.

10. The sealing arrangement of claim 9, wherein the sealing member is positioned closer to an axial end of the first pipe as compared to the damping member.

11. The sealing arrangement of claim 1 further including an auxiliary flange circumferentially disposed on the first pipe, the auxiliary flange configured to press the damping member against the first flange.

12. The sealing arrangement of claim 11 further including a backing member disposed between the damping member and the auxiliary flange, the backing member conforming to shape of the damping member.

13. The sealing arrangement of claim 11 further including a fastening member to lock the auxiliary flange, the first flange and the second flange.

14. A sealing arrangement for a first pipe and a second pipe, the sealing arrangement comprising:
a sealing member disposed between the first pipe and the second pipe, the sealing member configured to provide a seal between the first pipe and the second pipe;
a first flange circumferentially disposed on the first pipe;
a damping member circumferentially disposed in contact with the first pipe, the damping member having a first slanted side supported by the first flange; and
an auxiliary flange circumferentially disposed on the first pipe and configured to press the damping member against the first flange, the auxiliary flange being fastened with the first flange.

15. The sealing arrangement of claim 14 further including a groove on an exterior surface of the first pipe, wherein the sealing member is receivable in the groove.

16. The sealing arrangement of claim 14, wherein the damping member has a trapezoidal cross-section with a wider side in contact with the first pipe.

17. The sealing arrangement of claim 14 further including a backing member disposed between the damping member and the auxiliary flange, the backing member conforming to shape of the damping member.

18. A damping member adapted to retro-fit with a sealing arrangement having a sealing member provided between a first pipe and a second pipe, the damping member comprising:
a first slanted side configured to be supported by a first flange, the first flange circumferentially disposed on the first pipe; and
a second slanted side configured to be pressed by an auxiliary flange against the first flange, the auxiliary flange circumferentially disposed on the first pipe.

19. The damping member of claim 18 having a trapezoidal cross-section with a wider side configured to be in contact with the first pipe.

20. The damping member of claim 18 is made of an elastomeric material.
